(19) United States
(12) Patent Application Publication
(10) Pub. No.: US 2024/0025566 A1
(43) Pub. Date: Jan. 25, 2024

(54) Orbital Satellite Racing

(71) Applicant: Momentus Space LLC, San Jose, CA (US)

(72) Inventors: Joseph Mark Oorebeek, Palo Alto, CA (US); Robert Erik Schwarz, Los Gatos, CA (US); David Robert Buckley Biggs, Palo Alto, CA (US); Charles Jonathan Chase, Savannah, GA (US)

(21) Appl. No.: 17/872,956

(22) Filed: Jul. 25, 2022

(51) Int. Cl. B64G 1/24; B64G 1/14; B64G 1/10

(52) U.S. Cl. CPC B64G 1/242; B64G 1/14; B64G 1/1085

(57) ABSTRACT

A space vehicle competition management system includes an orbital transfer vehicle (OTV) and a control unit. The OTV is configured to retain space vehicles (SVs) while the OTV transfers the SVs from an initial altitude of a launch vehicle to a desired altitude, and deploy the plurality of SVs at a series of offset locations and respective times representing starting points of the competition. Furthermore, the control unit is configured to receive signals indicative of waypoint arrival times for one or more of the SVs at one or more waypoints along a course of the competition, and compute one or more metrics indicative of relative performance of the plurality of SVs in the competition.

### FIELD OF THE DISCLOSURE

The present disclosure generally relates to operating space vehicles and, more specifically, to a system and method for conducting a space vehicle competition with a racing component.

### BACKGROUND

With increased commercial and government activity in Near Space, a variety of spacecraft and missions are under development. For example, a spacecraft with significant orbital transfer capabilities may be dedicated to delivering payloads such as satellites from one orbit to another, cleaning up space debris, making deliveries to space stations, etc. On the other hand, small satellites may fulfill missions of communication, observing and measuring the thermosphere, remote observation of Earth's surface, etc. The different missions require development of new technologies, particularly associated with miniaturization of space vehicles deployed in Near Space. Though commercial applications, government investments, and private prize funds have contributed to the development of technology, engaging public interest and incentivizing performance improvements of small satellites remains a challenge.

### SUMMARY OF THE DISCLOSURE

In one embodiment, a space vehicle competition management system includes an orbital transfer vehicle (OTV) and a control unit. The OTV is configured to simultaneously retain a plurality of space vehicles (SVs) while the OTV transfers the plurality of SVs from an initial altitude of a launch vehicle to a desired altitude, and when at the desired altitude, deploy the plurality of SVs at a series of offset deployment locations and respective offset deployment times representing starting points of the competition. Furthermore, the control unit is configured to receive signals indicative of waypoint arrival times of one or more of the plurality of SVs at one or more waypoints along a course of the competition, and compute, based at least in part on the waypoint arrival times, one or more metrics indicative of relative performance of the plurality of SVs in the competition.

In another embodiment, a method of managing a space vehicle competition includes simultaneously retaining a plurality of space vehicles (SVs) on an orbital transfer vehicle (OTV) while the OTV transfers the plurality of SVs from an initial altitude of a launch vehicle to a desired altitude. The method further includes deploying, using the OTV, the plurality of SVs at a series of offset deployment locations and respective offset deployment times representing starting points of the competition. Still further, the method includes receiving, at a control unit, signals indicative of the arrival times representing times at which one or more of the plurality of SVs are proximate to one or more waypoints along a course of the competition. And still further, the method includes computing, using the control unit, based at least in part on the arrival times, one or more metrics indicative of relative performance of the plurality of SVs in the competition.

### BRIEF DESCRIPTION OF THE DRAWINGS

FIG. 1A schematically illustrates an example embodiment of a space vehicle competition management system prior to deploying space vehicles (SVs) from an orbital transfer vehicle (OTV).

FIG. 1B schematically illustrates the example embodiment of a space vehicle competition management system of FIG. 1A after deploying SVs from the OTV.

FIG. 2 schematically illustrates an example launch and deployment sequence for the OTV and the SVs of FIGS. 1A and 1B.

FIG. 3 schematically illustrates an environment within which an example embodiment of a space vehicle competition management system may operate.

FIG. 4 schematically illustrates a visualization system of a space vehicle competition management system.

FIG. 5 schematically illustrates an example space vehicle which may serve as an OTV of this disclosure.

FIG. 6 illustrates an example method 600 of managing a space vehicle competition.

### DETAILED DESCRIPTION

The systems, methods, and space vehicles of this disclosure generally relate to a concept of a competition or a race among a number of space vehicles. Popularization of such a competition can accelerate development of space technology and create a pipeline of skilled and motivated engineers. Sponsorship, entertainment, and advertising opportunities may grow and fund technological development.

A variety of challenges in conducting a space vehicle competition include delivering the space vehicles to a starting point of the competition, deploying the space vehicles at a desired altitude and/or orbit in a tractable and equitable manner, and measuring relative performance of the space vehicles. The methods, systems, and space vehicle configurations of the present disclosure address the challenges above.

Competition objectives may include events directly related to orbital control. A competition management system may measure altitude, inclination, eccentricity and right ascension of the ascending node (RAAN) of an orbit of a competing space vehicle. Competition objectives may include changes to orbit properties within a given timeframe. Competition objectives may also include interactions with the external reference frames; passing over a specific point(s) on the earth ground track, passing through a specific volume of 3D space around the earth (the volume may be fixed or mobile). The competition management system may award points for achieving each objective, scaled in the order of achievement, and weighted based on a determined level of difficulty. Additionally or alternatively, competition objectives may be “first past the post” races, i.e. measuring time of arrival of space vehicles to a given end point. Still additionally or alternatively, a competition objective may include maintaining a spatial relationship (a formation) among two or more space vehicles (e.g., two or more space vehicles on a same team in the competition).

Other potential objectives may be based less on orbital mechanics and more on the space environment. These may include data processing and communications challenges, or pointing/observation challenges (e.g., cycling the spacecraft through controlled rotations of 180 degrees to point an onboard camera at different targets). These objectives may include a data processing task requiring upload and display of digital messages (e.g., for social media posts) or a pointing task of selectively moving different terrestrial regions in or out of the camera field of view.

Timekeeping and safety offer some of the greatest challenges for the competition management system. Lapses in ground-station coverage may create dead zones where no communication with a space vehicle is possible, while self-reported (by the space-vehicles) positions (for instance based on GPS) may have inaccuracies beyond tens of meters. For this reason, target volumes and spacing between vehicles may need to be increased to ensure no ambiguity in position within a race.

Safety is another challenge for the parameters of a competition and operation of a competition management system. Collisions between vehicles even in moderately similar orbits may have relative velocities of tens of meters per second, almost guaranteeing destruction of the vehicle and posing a hazard for other space objects. Collisions may also lead to a revocation of launch licenses.

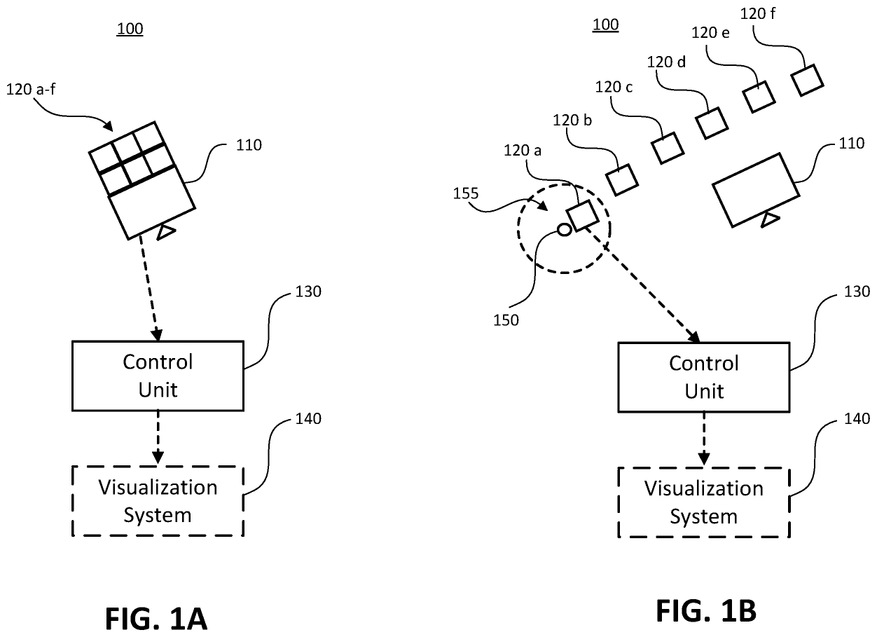

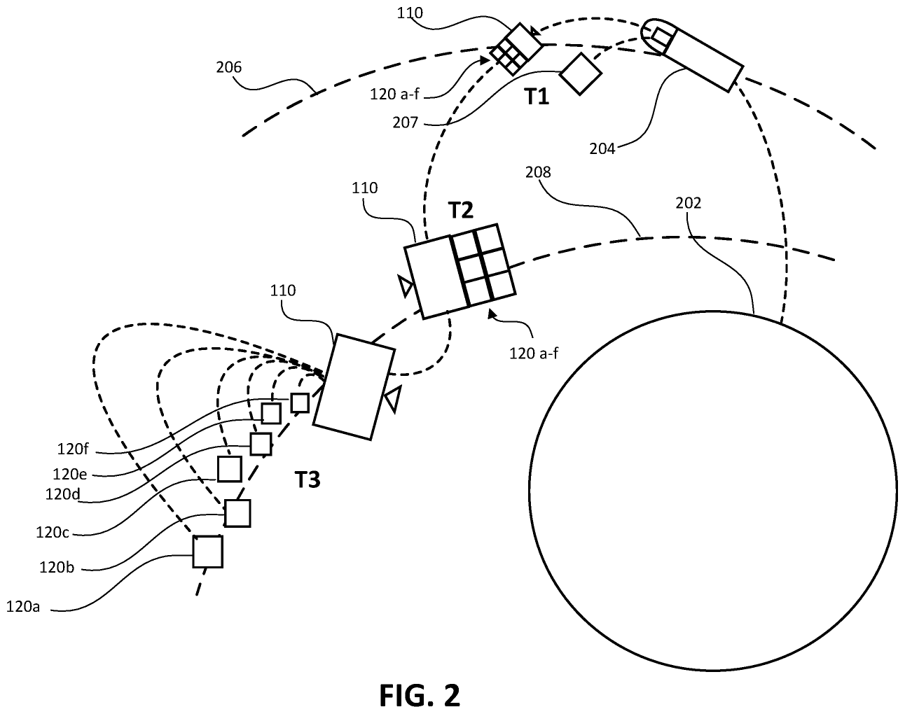

FIG. 1A schematically illustrates an example embodiment of a space vehicle competition management system 100. The system 100 includes an orbital transfer vehicle 110 (OTV 110). The OTV 110 is configured to simultaneously retain space vehicles 120 a-f (SVs 120 a-f) while the OTV 110 transfers the SVs 120 a-f from an initial altitude and/or orbit of a launch vehicle (e.g., an SSO orbit near 600 km) to a desired altitude and/or orbit, as schematically illustrated in FIG. 2. Although six SVs 120 a-f are illustrated in FIGS. 1A, 1B, 2, and 3 below, the competition management system 100 may manage a competition among any suitable number of satellites (e.g., 2, 3, 4, 6, 10, 16, 24, 48, etc.). As illustrated in FIG. 1B, the OTV 110 is also configured to release or deploy the plurality of SVs 120 a-f into a space environment at a series of offset deployment locations and respective offset deployment times representing starting points of the competition. The OTV 110 may be configured to retain, transport, and deploy all of the SVs 120 competing in the competition, or a subset of all SVs 120 competing in the competition. In some embodiments or scenarios, the competition management system 100 can include multiple OTVs acting substantially independently or in coordination, e.g., to allow for more competitors in a single race. The SVs 120 a-f may be small satellites (e.g., CubeSats of 1U, 3U, 6U, or 12U form factors). In some embodiments, the SVs may be larger or smaller satellites than the standard CubeSat sizes.

Each of the SVs 120 a-f may include a power system with a solar collector, a thruster system, and attitude control system (which may be combined with a thruster system), a communication system, and a control system. The communication system may include a radio receiver module, a radio transmitter, and optical receiver, and/or an optical transmitter.

The control system of an SV (e.g., one of SVs 120 a-f) may be configured to receive, after deployment of the respective SV as discussed below, a telecommand message via the communication system. The control system may operate the power system, the thruster system, and the attitude control system based on the telecommand message. In some embodiments, the control systems of the SVs 120 a-f may be configured to receive indications of respective current SV locations and attitudes and indications of one or more competition objectives. The control systems may operate the power system, the thruster system, and the attitude control system to adjust respective current SV locations and attitudes in view of the one or more competition objectives. For example, a competition objective may include arriving at a waypoint, and the control system may guide an SV (e.g., one of SVs 120 a-f) toward the waypoint.

The system 100 is configured for managing a competition and evaluating relative performances of the SVs 120 a-f (e.g., success in achieving competition objectives). To that end, the system 100 also includes a control unit 130 configured to receive signals indicative of the offset deployment locations and the respective offset deployment times of the SVs 120 a-f. In some embodiments, the control unit 130 may be in a communicative connection with the OTV 110. Additionally or alternatively, the control unit 130 and/or the OTV 110 may be pre-programmed with indications of the intended or nominal offset deployment locations and respective offset deployment times. That is, the control unit 130 and/or the OTV 110 may receive signals indicating the nominal deployment locations and/or times from one or more digital memory devices. In embodiments where the control unit 130 is in communicative connection with the OTV 110, the OTV 110 may generate indications of the offset deployment locations and the respective offset deployment times at or near the times of deployments. The OTV 110 may subsequently send, and the control unit 130 may receive signals (e.g., radio or free-space optical signals) with the generated indications of deployment locations and times.

The control unit 130 is configured to perform a number of computations pertaining to managing space vehicle competition. The computations that may be performed by the control unit 130 are described in more detail below with reference to the subsequent figures. To perform the computations, the control unit 130 may include one or more processors. The one or more processors may be disposed in a terrestrial (or planetary, lunar, etc.) environment and/or at a space platform, such a satellite. In some embodiments, the control unit 130 is a distributed control unit 130 disposed in both space and terrestrial environments.

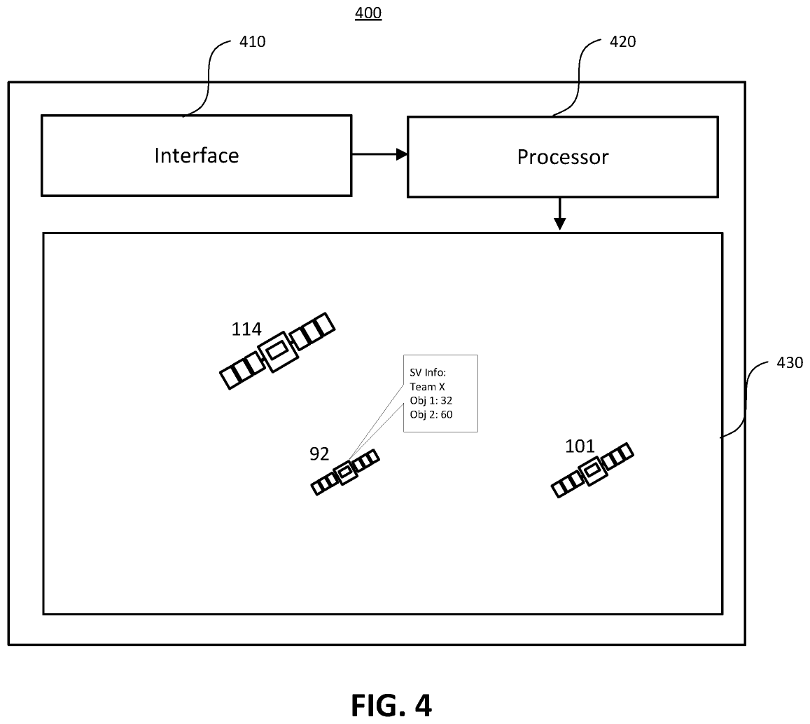

In some embodiments, the system 100 may include a visualization system 140 configured for displaying information about the competition. The visualization system 140 may be in communicative connection with the control unit 130, and the information displayed by the visualization system may be based at least in part on computations performed by the control unit 130. The visualization system 140 is described in more detail below with reference to FIG. 4

FIG. 1B schematically illustrates the example embodiment of the space vehicle competition management system 100 of FIG. 1A after the deployment of the space SVs 120 a-f from the OTV 110 at a series of offset deployment locations and respective offset deployment times. The OTV 110 may deploy the SVs 120 a-f when at a desired altitude (e.g., 100-500 km or another suitable altitude). In some embodiments, the OTV 110 is configured to deploy the SVs 120 a-f within a desired region delineated by orbital (e.g., Keplerian) coordinates. That is, the OTV 110 may deploy the SVs 120 a-f in a desired orbit. The desired orbit may be an elliptical orbit with a substantially varying altitude. The series of offset location may be disposed at substantially the same orbit, but different in true anomaly or time past perigee parameters.

The control unit 130 may be configured to receive a signal indicative of a time (i.e., waypoint arrival time) when SV 120a is in the vicinity 155 of a waypoint 150. The control unit 130 may compute a metric of performance for SV 120a based at least in part on the waypoint arrival time of SV 120a corresponding to the waypoint 150. The waypoint 150 may correspond to a start point, an end point, or an intermediate point of a competition course, for example, and may be stationary (e.g., relative to the Earth's surface) or mobile throughout the course of a competition. The waypoint 150 may be a waypoint shared among the SVs 120 a-f or may be specific to SV 120a. In some embodiments, at least some waypoints are designated for a specific SV or a specific set of SVs. For example, different SVs may report arrival at different waypoints at distinct locations. The competition management system may compute or recognize waypoint locations for respective SVs based at least in part on the offset deployment times and/or locations. Waypoints may be staggered along a competition course to reflect staggered deployment locations of the SVs 120 a-f. The control unit 130 may compute the metric of performance for SV 120a based also on the deployment location and/or the deployment time of SV 120a. More generally, the control unit 130 may be configured to receive signals indicative of waypoint arrival times for one or more of the SVs 120 a-f at one or more waypoints (e.g., waypoint 150) along a course of the competition. Furthermore, the control unit 130 may compute one or more SV performance metrics based at least in part on the offset deployment locations, the respective offset deployment times, and the waypoint arrival times of the SVs 120 a-f. The performance metrics are indicative (at least collectively) of relative performance of the SVs 120 a-f in the competition. For example, the performance metric(s) may include total distance traveled by each of the SVs 120 a-f, number of waypoints arrived at by each of the SVs 120 a-f, ETAs of each of the SVs 120 a-f (for an intermediate or final waypoint), a current ranking (e.g., based on any of the example metrics above), and so on. Alternatively, or in addition, performance metrics may include points scored by each of the SVs a-f in the course of the competition. The SVs 120 a-f may score points based on achieving objectives (e.g., arriving at waypoints, capturing and sending images, etc.) and/or quantitative evaluations of the achievements of the objectives (e.g., speed, proximity to waypoints, alignments in captured images, etc.). The visualization system 140 may be configured to receive (from the control unit 130) and display the metrics indicative of relative performance of the SVs 120 a-f.

FIG. 2 schematically illustrates an example launch and deployment sequence for the OTV and the SVs of FIGS. 1A and 1B. Launched from a terrestrial (or lunar) surface 202, a launch vehicle 204 may arrive at an altitude of an orbit 206. At time T1, the launch vehicle 204 may deploy the OTV 110 carrying the SVs 120 a-f along with other payload 207. Payload 207 may have orbit 206 as the destination.

By time T2, the OTV 110 may transfer the SVs 120 a-f to a different, desired altitude and/or orbit 208. The orbit 208 may have a higher or lower mean altitude than the orbit 206. One or both of the orbits 206 and 208 may be substantially circular orbits. For example, the orbit 206 may be a SSO with an altitude near 600 km. The orbit 206 may be another suitable orbit that is elliptical or substantially circular in shape, with a perigee altitude of 100, 200, 300, 400, 500, 700, 1000, 2000, or any other suitable altitude. In some embodiments, the orbit 206 is a Low Earth Orbit (LEO) or a Geostationary Transfer Orbit (GTO). It should be noted that, in the embodiments where the competition is in a lunar environment, suitable lunar orbits with respective altitudes may be used. For example, the launch vehicle 204 may deploy the OTV 110 at a Lunar Transfer Orbit (LTO) at T1, and the OTV 110 may then transfer the SVs 120 a-f to a lunar orbit by T2. The orbit 208 may be an orbit with low eccentricity and a mean altitude between 100 and 500 km. To achieve this altitude, the OTV 110 may transfer the SVs 120 a-f below or above the launch vehicle altitude at T1. Alternatively, the OTV 110 may remain at substantially the same altitude as the launch vehicle, and only transfer the SVs 120 a-f to different positions separated from the launch vehicle but substantially along the same orbit as the launch vehicle. Transferring the SVs 120 a-f to a relatively low altitude (possibly lower than the launch vehicle) may have a number of advantages. In the event that one or more of the SVs 120 a-f become damaged and/or disabled, the resulting debris may be more easily cleared from the orbital path of the competition by the competition managements system vehicles and/or simply as a result of increased aerodynamic drag at the lower altitude. For example, at altitude below 300 km, the debris may be cleared in several weeks or months, in comparison to several years at 600 km. Furthermore, the aerodynamic drag presents a challenging control problem to competitors, potentially leading to novel approaches for control algorithms. Further still, shorter period time of the lower orbital altitude may lead to higher ground station contact time and/or higher rate of encountering waypoints, facilitating management of the competition.

By time T3, the OTV 110 deploys the SVs 120 a-f at a series of offset deployment locations and respective offset deployment times. The deployment locations may be separated along the general orbit intended for the competition by at least 20 km, or by any other suitable minimum distance. The deployment locations may also be separated in altitude (e.g., by at least 1 km, or by any other suitable minimum distance), to further lower the likelihood of collision. The deployment times may be separated by 1, 2, 5, 10, or 20 seconds, 1, 2, 5, 10, or 20 minutes, 1, 2, or 5 hours, or any other suitable regular (or possibly irregular) time intervals. Because the OTV 110 and the deployed SVs 120 a-f may be moving at similar velocities, the OTV 110 may maintain separations between deployment locations within some maximum offset distance (e.g., 5 m, 100 m, 1 km, 5 km, 50 km, 100 km, 500 km, etc.), with deployment separation times of 1, 2, 5, or 10 minutes, etc. In the embodiments where the SVs 120 a-f are CubeSats, the OTV 110 may include one or more CubeSat deployers. The deployment process may impart different momentum vectors to each of the deployed SVs 120 a-f. The OTV 110 may adjust the deployment times and/or locations based on the varying degrees om momentum. Furthermore, the OTV 110 may engage one or more thrusters and adjust velocity and/or attitude between successive deployments. The OTV 110 adjustments may reduce probability of collisions between successively deployed SVs and/or compensate for different deployment times with respective adjustment to SV velocities upon deployment. The OTV 110 may control deployment times with a high degree of accuracy (e.g., to within less than a second, or to within 1, 2, 5, 10, or 20 seconds, etc.). Additionally or alternatively, the OTV 110 may control deployment locations with a high degree of accuracy (e.g., to within less than a meter, or to within 1, 2, 5, 10, 20, 50, or 100 meters, etc.).

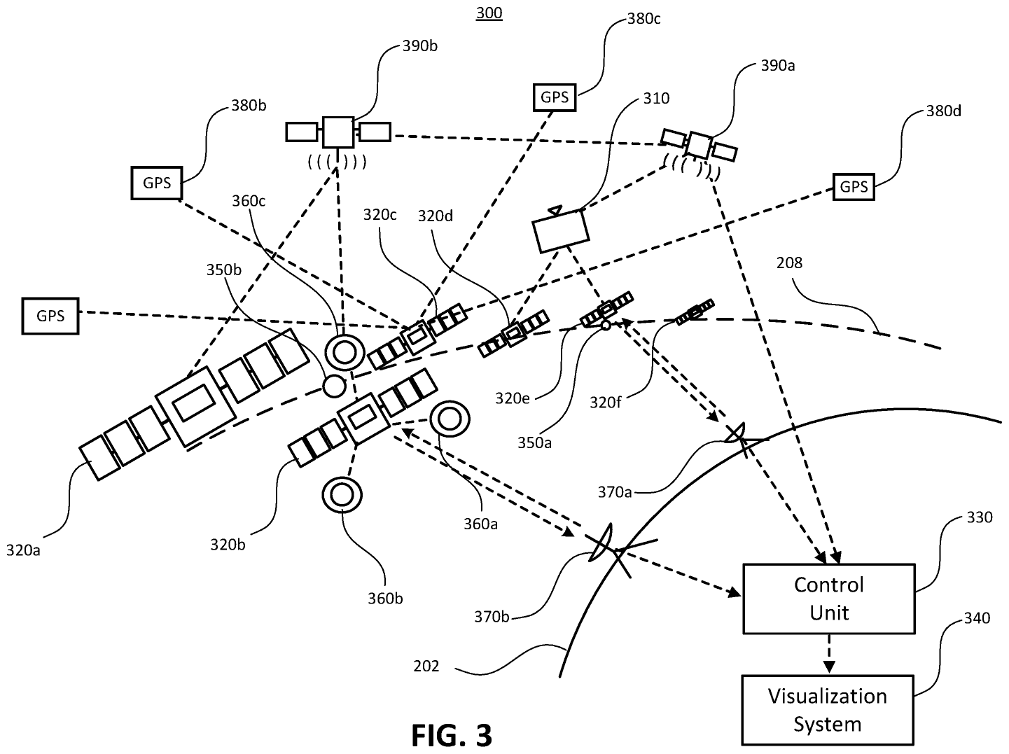

FIG. 3 schematically illustrates an environment 300 within which an example embodiment of a space vehicle competition management system (e.g., system 100) may operate. The environment 300 is a combination of space and terrestrial (or lunar, planetary, etc.) environments in which the system (i.e., the components of the system) along with objects and/or locations with which the system interacts. The system includes an OTV 310 (e.g., OTV 110) configured to retain, transfer, and deploy SVs 320 a-f (e.g., SVs 120 a-f) as described above. Additionally, the system includes a control unit 330 configured to monitor and evaluate the performance of the SVs 320 a-f. The system may include a visualization system 340 for displaying information about the SVs 320 a-f, the competition route (e.g., the path of the race and/or the locations of the waypoint(s)), and/or performance evaluations generated by the control unit 330.

The environment 300 may include waypoints 350 a, b which may lie, for example, along the orbital path 208. The environment 300 may include one waypoint (i.e., a common “finish line”), or any other suitable number of waypoints (2, 3, 10, etc.). Some waypoints may be designated for a particular SV of the SVs 320 a-f, or for a set of two or more of the SVs 320 a-f. The waypoints 350 a, b may correspond, respectively, to a start point and an end point of a competition course, for example. Alternatively, the waypoints 350 a, b may correspond to intermediate points of the competition. In some embodiments, the waypoints 350 a, b are virtual points in space designated by sets of coordinates that are static (i.e., stationary in the Earth's frame of reference) or dynamic (i.e., changing in the Earth's frame of reference). In other embodiments, waypoints may include physical objects disposed in space to demarcate a course. In the example embodiment, the system may include gateway devices (360 a-c) in the vicinity of the waypoint 350b. In a sense, the location of the waypoint 350b is in reference to the gate devices 360 a-c. The system may use any suitable number of gate devices (e.g., 1, 2, 3, 4, 5, 6, etc.) in the vicinity of a waypoint.

The environment 300 may include ground stations 370 a and b disposed on the Earth's surface 202, navigation satellites 380 a-d of any suitable navigation system (e.g., GPS), and/or communication network satellites 390a, b. More generally, the environment 300 may include any suitable number of ground stations (for example, to cover major land masses, minimize dead zones, etc.), navigation satellites, and/or communication satellites. In some embodiments, a competition management system may include at least some ground stations, navigation satellites, and/or communication satellites specifically configured to facilitate the management of the competition. The components of the competition management system and other devices in the environment 300 may be communicatively connected with each other. Example communicative connections within the environment 300 are schematically illustrated with short-dashed lines and discussed in more detail below.

In operation, the control unit 330 of the system may receive signals indicative of deployment times via one of the ground stations 370 a, b and/or one of the communication network satellites 390 a, b. For example, the OTV 310 may record, using a GPS receiver, the GPS time of a deployment for one of the SVs 320 a-f and send a radio message with an indication of the deployment time. The message may then be received by one of the ground stations 370 a, b and/or one of the communication network satellites 390 a, b and relayed to the control unit 330. Additionally or alternatively, the OTV 310 may record a time stamp on to a memory device disposed at an SV (e.g., SVs 320 a-f) prior to deploying the SV. That is, the OTV 310 may generate and transfer (e.g., via an electrical, optical, or wireless interface) to each SV a data packet with a time stamp and/or a location stamp indicative of a respective deployment time and/or a deployment location. In some embodiments, the deployment mechanism may trigger a recording of a timestamp at an SV (e.g., SVs 320 a-f) by the SV electronics. The signal indicative of the deployment time may then be sent to one of the ground stations 370 a, b by the respective SV.

The control unit 300 may receive, via one of the ground stations 370 a, b and/or one of the communication network satellites 390 a, b, a signal indicative of an arrival time of one of the SVs 320 a-f at one of the waypoints 350 a, b. In some embodiments, the signal indicative of the arrival time is “self-reported” by one of the SVs 320 a-f, e.g., SV 320 c arriving at the waypoint 350 b. The SV 320c may, for example, determine a location using an on-board GPS receiver in communicative connection with GPS satellites 380 a-d. The control system of the SV 320 c may determine, based on proximity to the location of the waypoint 350b, whether the location corresponds to an arrival at the waypoint 350 b. The control system of the SV 320 c may then make a record of GPS time corresponding to the arrival time. In some embodiments, based on competition objective (i.e., when proximity of arrival improves a performance metric) and/or a telecommand message, the internal control system of the SV 320 c may operate the SV 320 c (autonomously and/or guided by telecommand) to approach closer to the waypoint 350 b. In a sense, in some embodiments, proximity of arrival and arrival time are trade-offs for improving a score (achieving high metrics of relative performance). In any case, the SV 320 c may record a suitable arrival time and/or the proximity to the waypoint 350 and send a signal indicative of the arrival to the control unit 330 via a ground station (e.g., ground station 370 b) and/or a communication satellite (e.g., satellite 390 b).

In the embodiments one or more gate devices (e.g., 360 a-c) of the system 300 may facilitate determining arrival time at waypoint (e.g., waypoint 350 b). In some implementations, an SV (e.g., SV 320 b) may “self-report” an arrival-time time based on observations, measurements of, and/or signals received from the one or more gate devices. For example, the SV may include a camera configured to capture an image of a gate device. Proximity to the gate device may be evaluated based on the captured image. The gate device may be collocated with the way point, in which case proximity to the gate device is indicative of the proximity to the waypoint. Alternatively, the SV may evaluate proximity to a way point based on proximities or angles to a group of gate devices (e.g., gate devices 360 a-c) by trilateration or triangulation, respectively. For example, the pointing direction of the SV camera capturing an image of each gate device may indicate a relative direction of the gate device for triangulation. Additionally or alternatively, the gate devices may include radio beacons. The radio beacons may be amplitude-modulated (e.g., pulsed) and/or frequency-modulated (e.g., chirped), or continuous wave (CW). The phases of CW transmissions or carriers and/or modulation parameters of modulated radio transmissions of the beacons may be synchronized among the gate devices. The SV may detect (e.g., using the communication system or other on-board instrumentation) relative phases or modulation parameters (e.g., frequency, time of arrival of a pulse, etc.) to estimate distances to the gate devices for the trilateration to determine the location of the SV with respect to the waypoint. The beacons on the gate devices may be optical beacons implemented, for example, with lasers or light emitting diodes (LEDs). To conserve power, the gate devices may activate the beacons in response to detecting that an SV is in proximity (e.g., by detecting a radio transmission from the SV). In some embodiments, an SV (e.g., SV 320 b) may include an active system (e.g., radar or lidar) for generating measurements indicative of angles and/or proximities to gateway devices (e.g., gate devices 360 a-c), and use the generated measurements to determine proximity and/or orientation to a waypoint (e.g., waypoint 350 b). Such an active system may serve a dual purpose of avoiding collisions among the SVs 320 a-f.

More generally, a control system of one of the SVs 320 a-f may implement algorithms for collision avoidance with a second one of the SVs 320 a-f based on on-board sensors (e.g., camera, lidar, radar, etc.). Additionally or alternatively, one SV (e.g., SV 320 a) may receive via the communications system a message indicative of the location of a second SV (e.g., 320 b) and the internal control system of the SV may automatically (e.g., without any manual input) operate the thruster and attitude adjustment of the SV to avoid a collision based on the received message. Messages indicative of locations of some of the SVs 320 a-f sent to the other ones of the SVs 320 a-f may be generated by the competition management system 300. Additionally or alternatively, the SVs 320 a-f may communicate location information to each other, via, for example radio beacons. More generally, radio or optical beacons included on the SVs 320 a-f may facilitate more precise localization of the SVs by a competition management system using other SVs, gate devices (including, possibly, the OTV 310), ground stations, etc.

In any of the cases described above, detection of waypoint proximity and respective time using gate devices (e.g., gate devices 360 a-c) can result in higher-accuracy measurements of proximity and time than when using positioning satellites for corresponding measurements. Additionally or alternatively, using gate devices (e.g., gate devices 360 a-c) may enable detection of an orientation or attitude, or a sequence of orientations or attitudes, of an SV (e.g., SV 320 b). The competition management system may compare the orientation or attitude, or the sequence of orientations or attitudes, to competition objectives to evaluate performance of the SV in the competition.

In some embodiments, gate devices (e.g., gate devices 360 a-c) may be configured to measure proximity to an SV (e.g., SV 320 b) at a respective time, and/or an attitude or orientation of the SV and send signals indicative of the measurements to the control unit 300 via a ground station (e.g., ground station 370 b) and/or a communication satellite (e.g., satellite 390 b). To that end, the gate devices may include passive and/or active measurement devices (e.g., camera, radio receiver, optical receiver, lidar, radar, etc.) and a communication system to send signals indicative of the measurements. The gate devices may perform distance and/or orientation measurements, as well as triangulation and/or trilateration measurements, according to the principles discussed above in the context of measurements performed by SVs. The advantages of the gate devices 360 a-c (rather than the SVs 320 a-f) performing the measurements may include reducing the instrument requirements (and, possibly size and weight) of the SVs 320 a-f and/or maintaining integrity of the competition by avoiding incorrect or inconsistent measurement reports from the SVs 320 a-f.

In some embodiments, the OTV 310 is configured to perform a secondary function as a gate device. For example, subsequently to deploying the SVs 320 a-f, the OTV 310 may adjust the orbit to be out of phase (different orbital period) with the orbits of the SVs 320 a-f. The difference of orbital periods between the OTV 310 and the SVs 320 a-f may lead to the SVs 320 a-f periodically passing by the OTV 310. The OTV 310 may be configured to perform the measurements as discussed above in the context of gate devices 360 a-c (i.e., such that the OTV 310 itself serves as a gate device for a waypoint). Additionally or alternatively, the OTV 310 may be configured to evaluate continued operational functionality of the SVs 320 a-f. The OTV 310 may be configured to clear an SV (e.g., one of the SVs 320 a-c) from the orbital path of the competition when observing a terminal malfunction.

In some implementations, gate devices (e.g., gate devices 360 a-c) may be space-borne (e.g., between 100 and 500 km in altitude or at another suitable altitude). Additionally or alternatively, at least some gate devices may be terrestrially-based. Highly directional radio or optical devices included on or in the gate devices may determine angles to the SVs 320 a-f and aid in determining waypoint arrival times and/or locations of the SVs 320 a-f. Multiple terrestrially-based gate devices may enable triangulation of locations of the SVs 320 a-f.

The control unit 330 is configured to compute, based at least in part on the indications of the waypoint arrival times (and possibly also based on indications of the offset deployment locations and respective offset deployment times, and/or other information), one or more metrics indicative of relative performance of the plurality of SVs in the competition (e.g., rankings, points, and/or other performance metrics as discussed above). As described above, either the OTV 310 or the SVs 320 a-f may generate and send signals indicative of the offset deployment locations and the respective deployment times to the control unit 330 via a ground station 370 a or b. Also as described above, either the SVs 320 a-f or the gate devices 360 a-c may generate and send signals indicative of the waypoint arrival times to the control unit 330 via a ground station 370 a or b. Additionally or alternatively, either the SVs 320 a-f or the gate devices 360 a-c may generate and send signals indicative of SV locations, SV proximities to one or more waypoints, and/or SV attitudes or orientations to the control unit 330 via a ground station 370 a or b. The control unit 330 may be configured to compute one or more metrics indicative of relative performance of the plurality of SVs in the competition based at least in part on the indications of SV locations, SV proximities to one or more waypoints, and/or SV attitudes or orientations.

The control unit 330 may be configured to compute at least one of the metrics of relative performance according to an equation uniformly decreasing with proximity to a waypoint at a respective one of the arrival times. The control unit 330 may compute a metric of performance, for example, as linearly or quadraticly decreasing with proximity to a waypoint at a respective one of the arrival times. In other embodiments, performance points may be awarded for entering a spatial envelope around a waypoint. For example, entering a series of increasing spatial envelopes (e.g., 50 m, 200 m, 1 km around a waypoint), may earn an SV different amount of points.

The control unit 330 may be configured to compute at least one of the metrics of relative performance according to an equation uniformly decreasing with time difference between a reference time and a respective one of the arrival times. In some embodiments, the control unit 330 may compute the reference time as a different, respective reference time for each of the SVs 320 a-f, based at least in part on the respective deployment times and/or deployment locations. That is, the control unit 310 may compensate for the delays or positional offsets associated with deployments. Additionally or alternatively, the management system 300 may be configured to compensate for deployment delays with deployment locations to allow SVs (e.g., SVs 320 a-f) with substantially equal performance to arrive at waypoints at substantially the same time. Still additionally or alternatively, locations of waypoints may be different for respective SVs (e.g., SVs 320 a-f), generating, effectively, alternate competition courses for the respective SVs. The alternative courses or other suitable adjustments may compensate for orbital path or location (e.g., phase changes, altitude changes, and/or declination changes) between deployments.

The control unit 330 may compute a metric of performance, for example, as linearly or quadraticly decreasing with the time difference between a reference time and a respective one of the arrival times. Alternatively, different amounts of performance points awarded to the SVs may depend at least in part on the order of arrival rather than the specific times of arrival.

The control unit 300 may combine performance metrics for time and proximity into a single metric by adding points for each, creating a weighted root-mean-square value or in any other suitable manner. A competition may have a variety of other objectives for the SVs 320 a-f, such as following a specific orbit, taking pictures of earth, space objects, and/or gate devices, intercepting, decoding, and resending radio transmissions (e.g., possibly including sending IP messages for posting a picture on social media, or retweeting a tweet), and/or any other suitable objectives. The control unit 330 may combine the performance metrics or points for achievement and/or performance on the objectives in any suitable manner.

In some embodiments, the control unit 330 may send the computed metrics of performance and/or other suitable information about the SVs 320 a-f to the visualization system 340. The visualization system may include one or more displays for displaying the information received from the control system 330 to observers of the competition. At least some of the observers may be operators of the SVs. The operators of the SVs 320 a-f may generate command messages based on the displayed information, which may be sent (e.g., via ground stations 370 a, b) to respective satellites as telecommand messages. The control systems of the SVs 320 a-f may then operate the SVs according to the commands.

Others observers of the competition may include subscribers to one or more media services. The visualization system 340 may interface with servers of the video services to display information to the subscribers.

FIG. 4 schematically illustrates a visualization system 400, which may be an embodiment of the visualization system 140 or the visualization system 340. The system includes an interface 410 in communicative connection with a processor 420, which is in turn in communicative connection with a display 430. The interface may be configured to receive, e.g., via an electrical, a wireless, or an optical connection, data (which may be modulated and/or encoded) from a control unit (e.g., control unit 130 or 330). The interface 410 may be a secure interface, securely aggregating data from the control unit before sending to a single or distributed processor 420. The processor 420 may be configured to receive the data (which may be received, demodulated, and/or decoded by the interface 410) and compute visual information to send to the display 430. The display may be a screen (on a personal device or a shared screen suitable for a stadium or other public viewing), an augmented reality (AR), a virtual reality (VR) display (e.g., a headset or VR cave, etc.), or any other suitable display. In some embodiments, the visualization system may generate video information in a suitable format and send the generated video to a media outlet or another suitable destination. The visualization system may include a user interface (UI). In some embodiments, the display 430 may be a touch-screen display which also serves as the UI.

The visualization system 400 may be configured to display information about one or more of the SVs on the display 430. The displayed information may include a graphical representation of each SV. In some embodiments, the graphical representations can be based on computer-aided design (CAD) files, or different CAD files for different SVs. For example, the visualization system 430 may receive the CAD files from a manufacturer of the respective SV and/or SV components. In other example embodiments, the graphical representations are simplified and/or stylized graphical components, and do not necessarily reflect the true appearance of the SVs. The displayed information may include an indication of location or position of one or more of the SVs at a given time in the competition. Additionally or alternatively, the information may include SV measured and/or computed (past and/or predicted) paths or trajectories. Paths or trajectories displayed at the display 430 may be computed by the visualization system 400 and/or a control unit (e.g., control unit 130 or 330). In some embodiments, the processor 420 may be configured to compute, based on SV positions at two disparate times, a position at a third time. The computation may include interpolating or extrapolating positions based, for example, on orbital dynamics. The computation of position at a time for which location or position is not reported may facilitate contemporaneous positions of two or more SVs on the display 430. In some embodiments, a control unit (e.g., control unit 330 of the system 300) may compute an SV location at a time for which location is not reported and send the computed location to the visualization system 400 via the interface 410. In some embodiments, at least some of the times and/or locations or distances displayed on the visualization system 400 are adjusted for the offset deployment times and/or locations of the SVs. Either a control unit of the management system or the processor 420 may compute the adjusted times and/or distances or locations. For example, the visualization system 400 may display a true position and time for one of the SVs (e.g., a competition leader, one selected by an observer or operator, etc.) and computed (adjusted) times, positions, and/or paths of other SVs. Computed “overlaid” positions and/or trajectories may present a clearer view of relative competition performance of the SVs in view of offset deployment times and locations. The visualization system 400 may cause the display 430 to depict any one or more of the performance metrics discussed above (e.g., distance traveled, number of waypoints arrived at, estimated times of arrival, rankings, etc.).

The visualization system 400 may display (e.g., on the display 430) indications of a metric of performance of one or more SVs. In FIG. 4, for example, three SVs are schematically displayed. The size of SV icons may correspond to proximity to a waypoint (e.g., waypoint 150 or 350a). Additionally or alternatively, x- and y-coordinates on the display 430 may indicate position or location of the SVs. The visualization system 400 may display (on the display 430) metrics of performance, for example, as point scores next to the SV icons.

In some embodiments, the display 430 may be indicative of a view from the perspective of one of the SVs (e.g., one selected by an observer with a touch-screen tap). The view may be based on the information captured by an on-board camera of the SV and/or computed from the SV location, attitude, and/or velocity information reported by the SV and/or measured by the competition management system. For example, the displayed view may include a computed star field and/or an Earth view as would be visible from the SV. Furthermore, the perspective of one SV shown in the display 430 may include a captured and/or computed view of other SVs. The UI of the visualization system 400 may allow an observer or SV operator to scroll through a variety of views and/or pan or Zoom through a particular view. For example, an operator or observer may touch or click a displayed orbital path, a waypoint, and/or SV for more information, switch between a global view and a point of view of a particular SV, visualize performance of SVs on various objectives, display projected SV paths and predicted performance, etc.

At least a portion of the visualization system 400 may be incorporated into a command center where operators of the SVs may receive information about SV performance, generate telecommand messages for controlling the SVs, select or decline competition objectives, and/or observe other SVs. In some embodiments, SV operators may generate commands for the respective SVs with a touch-screen UI of the visualization system 400. For example, an operator may touch the display 430 to select waypoints, swipe across screen to reposition an SV, etc.

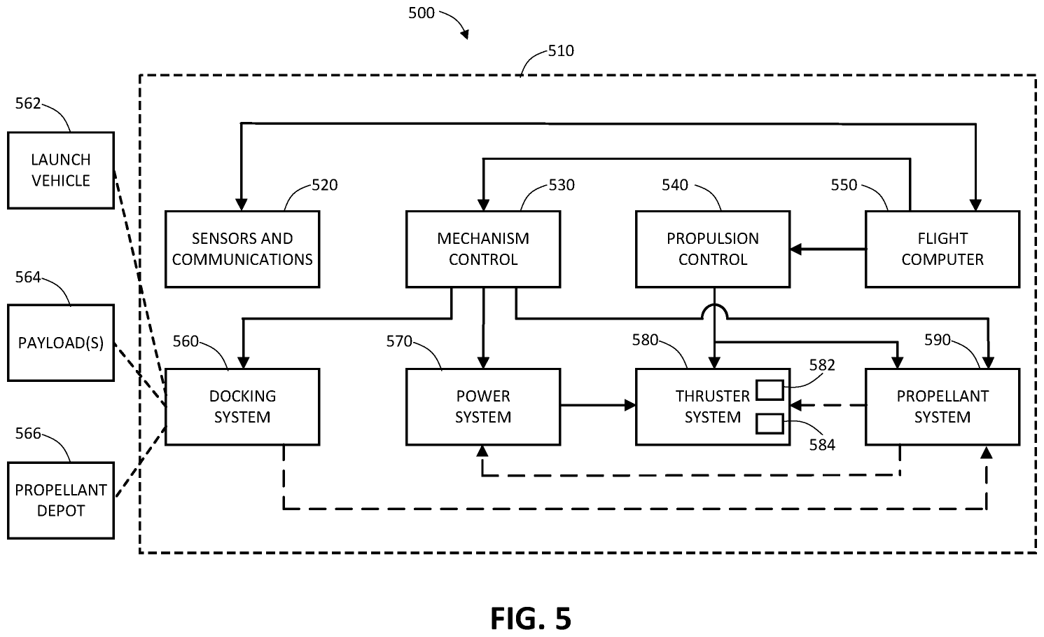

FIG. 5 is a block diagram of a spacecraft 500 configured for transferring competitor satellites (e.g., SVs 120 a-f or 320 a-f) as a payload between orbits. The spacecraft 500 can be an implementation of the OTV 110 or the OTV 310, for example. The implementations of the OTV functions with a competition management system (e.g., system 100 or 300) may depend on and interact with a variety of components and/or parameters of operation of the spacecraft 500.

The spacecraft 500 includes a number of systems, subsystems, units, or components disposed in, on, and/or coupled to a housing 510. The subsystems of the spacecraft 500 may include sensors and communications components 520, mechanism control 530, propulsion control 540, a flight computer 550, a docking system 560 (for attaching to a launch vehicle 562, one or more payloads 564, a propellant depot 566, etc.), a power system 570, a thruster system 580 that includes a primary propulsion (main) thruster subsystem 582 and an attitude adjustment thruster subsystem 584, and a propellant system 590. The one or more payloads 564 may include SVs (e.g., SVs 120 a-f or 320 a-f) of the present disclosure. Furthermore, any combination of subsystems, units, or components of the spacecraft 500 involved in determining, generating, and/or supporting spacecraft propulsion (e.g., the mechanism control 530, the propulsion control 540, the flight computer 550, the power system 570, the thruster system 580, and the propellant system 590) may be collectively referred to as a propulsion system of the spacecraft 500.

The sensors and communications components 520 may include a number of sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 520 may be communicatively connected with the flight computer 550, for example, to provide the flight computer 550 with signals indicative of information about spacecraft position and/or commands received from a ground station.

The flight computer 550 may include one or more processors, a memory unit, computer readable media, to process signals received from the sensors and communications components 520 and determine appropriate actions according to instructions loaded into the memory unit (e.g., from the computer readable media). Generally, the flight computer 550 may be implemented using any suitable processing hardware, such as, for example, a digital signal processing (DSP) circuit, an application-specific integrated circuit (ASIC), a field programmable gate array (FPGA), and/or a microprocessor configured to executed software instructions stored in a memory unit. More generally, the flight computer 550 may be implemented with any suitable electronic hardware and/or software components. The flight computer 550 may generate control messages based on the determined actions and communicate the control messages to the mechanism control 530 and/or the propulsion control 540. For example, upon receiving signals indicative of a position of the spacecraft 500, the flight computer 550 may generate a control message to activate one of the thruster subsystems 582, 584 in the thruster system 580 and send the message to the propulsion control 540. The flight computer 550 may also generate messages to activate and direct sensors and communications components 520.

The docking system 560 may include a number of structures and mechanisms to attach the spacecraft 500 to a launch vehicle 562, one or more payloads 564 (e.g., the SVs 120 a-f, 320 a-f), and/or a propellant refueling depot 566. The docking system 560 may be fluidicly connected to the propellant system 590 to enable refilling the propellant from the propellant depot 566. Additionally or alternatively, in some embodiments at least a portion of the propellant may be disposed on the launch vehicle 562 and outside of the spacecraft 500 during launch. The fluidic connection between the docking system 560 and the propellant system 590 may enable transferring the propellant from the launch vehicle 562 to the spacecraft 500 upon delivering and prior to deploying the spacecraft 500 in orbit.

The power system 570 may include components for collecting solar energy, generating electricity and/or heat, storing electricity and/or heat, and delivering electricity and/or heat to the thruster system 580. To collect solar energy, the power system 570 may include solar panels (e.g., solar array 160) with photovoltaic cells, solar collectors or concentrators with mirrors and/or lenses, or a suitable combination of devices. In the case of using photovoltaic devices, the power system 570 may convert the solar energy into electricity and store it in energy storage devices (e.g., lithium ion batteries, fuel cells, etc.) for later delivery to the thruster system 580 and other spacecraft components. In some embodiments, the power system 580 may deliver at least a portion of the generated electricity directly (i.e., bypassing storage) to the thruster system 580 and/or to other spacecraft components. When using a solar concentrator, the power system 570 may direct the concentrated (having increased irradiance) solar radiation to photovoltaic solar cells to convert to electricity. In other embodiments, the power system 570 may direct the concentrated solar energy to a solar thermal receiver or simply, a thermal receiver, that may absorb the solar radiation to generate heat. Still furthermore, using a solar concentrator, the power system 570 may perform electrolysis for generating chemical components for propulsion as described above. The power system 570 may use the generated heat to power a thruster directly and/or to generate electricity using, for example, a turbine or another suitable technique (e.g., a Stirling engine). The power system 570 then may use the electricity directly for generating thrust or storing electrical energy.

The thruster system 580 may include a number of thrusters (e.g., thrusters 170b or 570) and other components configured to generate propulsion or thrust for the spacecraft 500. Thrusters may generally include main thrusters in the primary propulsion subsystem 582 that are configured to substantially change speed of the spacecraft 500, or as attitude control thrusters in the attitude control thruster subsystem 584 that are configured to change direction or orientation of the spacecraft 500 without substantial changes in speed.

One or more thrusters in the primary propulsion subsystem 582 may be MET thrusters. In a MET thruster cavity, an injected amount of propellant (e.g., delivered via the liquid propellant transfer unit 120) may absorb energy from a microwave source (that may include one or more oscillators) included in the thruster system 580 and, upon partial ionization, further heat up, expand, and exit the MET thruster cavity through a nozzle, generating thrust.

Another one or more thrusters in the primary propulsion subsystem 582 may be solar thermal thrusters. In one embodiment, propellant in a thruster cavity acts as the solar thermal receiver and, upon absorbing concentrated solar energy, heats up, expands, and exits the nozzle generating thrust. In other embodiments, the propellant may absorb heat before entering the cavity either as a part of the thermal target or in a heat exchange with the thermal target or another suitable thermal mass thermally connected to the thermal target. In some embodiments, while the propellant may absorb heat before entering the thruster cavity, the primary propulsion thruster subsystem 582 may add more heat to the propellant within the cavity using an electrical heater or directing a portion of solar radiation energy to the cavity.

Other types of thrusters may also be used. For example, the primary propulsion subsystem 582 may also include chemical or electrical thrusters.

Thrusters in the attitude adjustment subsystem 584 may use propellant that absorbs heat before entering the cavities of the attitude adjustment thrusters in a heat exchange with the thermal target or another suitable thermal mass thermally connected to the thermal target. In some embodiments, while the propellant may absorb heat before entering thruster cavities, the thrusters of the attitude adjustment thruster subsystem 584 may add more heat to the propellant within the cavity using corresponding electrical heaters. Likewise, propellant may be evaporated in heat exchangers prior to the supply of propellant into high temperature electrolysis units.

The propellant system 590 may store the propellant for consumption in the thruster system 580. The propellant may include water, hydrogen peroxide, hydrazine, ammonia, or another suitable substance. The propellant may be stored on the spacecraft in solid, liquid, and/or gas phase. To that end, the propellant system 590 may include one or more tanks, including, in some embodiments, deployable tanks. To move the propellant within the spacecraft 500, and to deliver the propellant to one of the thrusters, the propellant system 590 may include one or more pumps, valves, and pipes. The propellant may also store heat and/or facilitate generating electricity from heat, and the propellant system 590 may be configured, accordingly, to supply propellant to the power system 570. In some embodiments, one or more electrolysis units may be configured to run in reverse as fuel cells to generate electricity.

The mechanism control 530 may activate and control mechanisms in the docking system 560 (e.g., for attaching and detaching a payload or connecting with an external propellant source), the power system 570 (e.g., for deploying and aligning solar panels or solar concentrators), and/or the propellant system 590 (e.g., for changing the configuration of one or more deployable propellant tanks). Furthermore, the mechanism control 530 may coordinate interaction between subsystems, for example, by deploying a tank in the propellant system 590 to receive propellant from an external propellant source connected to the docking system 560.

The propulsion control 540 may coordinate the interaction between the thruster system 580 and the propellant system 590, for example, by activating and controlling electrical components (e.g., a microwave source) of the thruster system 540 and the flow of propellant supplied to thrusters by the propellant system 590. Additionally or alternatively, the propulsion control 540 may direct the propellant through elements of the power system 570. For example, the propellant system 590 may direct the propellant to absorb the heat (e.g., at a heat exchanger) accumulated within the power system 570. Vaporized propellant may then drive a power plant (e.g., a turbine, a Stirling engine, etc.) of the power system 570 to generate electricity. Additionally or alternatively, the propellant system 590 may direct some of the propellant to charge a fuel cell within the power system 590. Still further, the attitude adjustment thruster subsystem 584 may directly use/consume the heated propellant to generate thrust.

The subsystems of the spacecraft 500 may be merged or subdivided in different embodiments. For example, a single control unit may control mechanisms and propulsion. Alternatively, dedicated controllers may be used for different mechanisms, thrusters (e.g., including a thruster of the present disclosure), valves, etc. In the preceding discussion, a “controller” may refer to any portion or combination of the mechanism control 530 and/or propulsion control 540.

It may be noted that the SVs of this disclosure may include at least some of the systems and/or components discussed with respect to the space vehicle 500. For example, components of the sensor and communications system 520, propulsion control 540, flight computer 550, power system 570, and/or thruster system 580 may be adapted for the SVs to implement competition objectives. More specifically, passive or active imaging sensors, magnetometers, inertial motion units (IMUs), Global Positioning System (GPS) receivers, etc., may be adapted by the SVs for navigating to waypoints and/or avoiding collisions. Radio and/or optical communication devices may be configured to communicate with one or more ground station to send telemetry data (or any downlink communications) and/or receive telecommand data (or any uplink communications), and/or with other SVs to verify locations, avoid collisions, etc. Furthermore, the sensor and communication components may aid in formation flying or achieving other objectives (e.g., imaging and/or communication) of the competition. Components of the flight computer 550 may be adapted by the SVs to perform autonomously or semi-autonomously portions of the competition. In some embodiments, SV human operators may send objectives (e.g., waypoint locations, camera pointing directions, etc.) and SV flight computers may operate the sensor and/or propulsion and attitude control to achieve the objectives. Additionally or alternatively, the flight computer may log time, location, and/or other performance data for later communications.

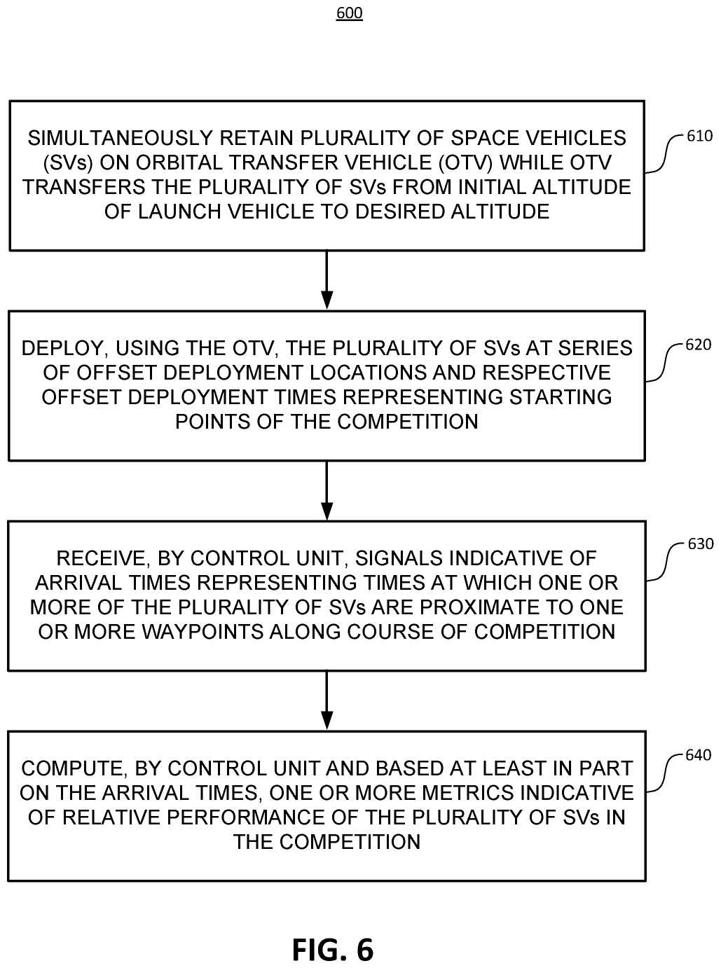

FIG. 6 illustrates a method 600 of managing a space vehicle competition. The method 600 may be implemented by and/or using a competition management system (e.g., system 100 or 300).

At block 610 the method 600 includes simultaneously retaining a plurality of SVs (e.g., SVs 120 a-f, 320 a-f) on an OTV (e.g., OTV 110, 310, possibly implemented as spacecraft 500) while the OTV transfers the plurality of SVs from an initial altitude of a launch vehicle to a desired altitude. Transferring the SVs to a desired altitude may include reducing (or increasing) orbital altitude by some minimum amount (e.g., at least 5 m, at least 100 m, at least 1 km, at least 50 km, etc.) relative to the altitude at which the launch vehicle deploys the OTV. In some embodiments, transferring the SVs to a desired orbit includes transferring the SVs to a suitable lunar orbit from a lunar transfer obit (LTO) that corresponds to the initial altitude of OTV deployment from the launch vehicle. For example, a lunar orbit race may be included in a larger objective of getting to the moon (and, possibly, back), and/or a competition challenge may include attempting to get one's own SV closer to the surface of the moon than any other SV, etc.

At block 620 the method 600 includes deploying, using the OTV, the plurality of SVs at a series of offset deployment locations and respective offset deployment times representing starting points of the competition. In some embodiments, deploying the SVs at offset deployment times and locations includes computing the deployment times and locations at least in part to minimize relative advantages for the SVs in the competition. Additionally or alternatively, computing the deployment times and locations may be based at least in part on reducing probabilities of collision among the SVs and/or between SVs and other objects in the space environment of the competition. Computing the offset deployment times and/or locations may be performed by the control unit of the competition management system. At least a portion of the control unit computing the offset deployment times and/or locations may be disposed at the OTV.

At block 630 the method 600 includes receiving, at a control unit, signals indicative of arrival times representing times at which one or more of the plurality of SVs are proximate to one or more waypoints along a course of the competition. The signals indicative of the arrival times may be generated by the SVs and/or by components of the competition management system. For example, generating signals indicative of arrival times may include measuring time and/or location of an SV in the vicinity of a waypoint using one or more gate devices disposed in the operating space-terrestrial environment (e.g., environment 300) of the competition. The method 600 may also include receiving at the control unit the offset deployment locations and the respective offset deployment times. Signals indicative of the offset deployment locations and/or deployment times may be generated by the OTV and/or by the SVs.

At block 620 the method 600 includes computing, by a control unit, based at least in part on the arrival times, one or more metrics indicative of relative performance of the plurality of SVs in the competition. In some embodiments, computing the metrics of relative performance is based at least in part on the offset deployment locations and the respective offset deployment times. In particular, when offset deployment locations and/or offset deployment times give an advantage to one SV over another, the competition management system may compensate for such advantages. The compensation may include computing the relative advantages based on the deployment times and/or locations of the SVs, locations of waypoints, and/or orbital dynamics.

Additionally or alternatively, the method 600 may include displaying, by a visualization system (e.g., the visualization system 400), information about at least one of the plurality of SVs. The information may include simultaneously displayed at least one of (i) a respective indication of time, (ii) a respective indication of position, and/or (iii) a respective indication of a metric of performance of one or more SVs. Displaying position and/or time information of the SVs may include computing, by the visualization system, adjusted or virtual positions of SVs that may be overlaid to better reflect relative performance in the competition. Displaying the information may be in response to observer or operator input via a user interface.

1. A space vehicle competition management system comprising:
an orbital transfer vehicle (OTV); and
a control unit,
wherein the OTV is configured to
simultaneously retain a plurality of space vehicles (SVs) while the OTV transfers the plurality of SVs from an initial altitude of a launch vehicle to a desired altitude, and
when at the desired altitude and/or in a desired orbit, deploy the plurality of SVs at a series of offset deployment locations and respective offset deployment times representing starting points of the competition; and
wherein the control unit is configured to
receive signals indicative of waypoint arrival times of one or more of the plurality of SVs at one or more waypoints along a course of the competition, and
compute, based at least in part on the waypoint arrival times, one or more metrics indicative of relative performance of the plurality of SVs in the competition.

2. The system of claim 1, wherein:
the control unit is further configured to receive signals indicative of the offset deployment locations and the respective offset deployment times of one or more of the plurality of SVs; and
the control unit is configured to compute the one or more metrics further based on the offset deployment locations and the respective offset deployment times.

3. The system of claim 1, wherein the control unit is further configured to:
receive signals indicative of proximity to respective waypoints at least some of the waypoint arrival times; and
compute the one or more metrics indicative of relative performance of the plurality of SVs in the competition based at least in part on the signals indicative of proximity.

4. The system of claim 1, wherein at least one on the waypoints corresponds to an end point of the competition.

5. The system of claim 1, further comprising:
one or more gate devices disposed at an altitude between 100 and 500 km, wherein:
at least one of the signals indicative of proximity to the respective waypoints is indicative of a distance between a respective one of the SVs and one of the one or more gate devices.

6. The system of claim 5, wherein at least one of the one or more gate devices is the OTV.

7. The system of claim 1, wherein the control unit is configured to compute at least one of the metrics of relative performance according to an equation uniformly decreasing with proximity to a waypoint at a respective one of the arrival times.

8. The system of claim 1, wherein the control unit is configured to compute at least one of the metrics of relative performance according to an equation uniformly decreasing with time difference between a reference time and a respective one of the arrival times.

9. The system of claim 1, wherein the desired altitude is between 100 km and 500 km.

10. The system of claim 1, wherein the desired altitude differs from a launch deployment altitude of the OTV by at least 5 meters.

11. The system of claim 1, wherein the series of offset deployment locations includes at least two consecutive deployments within 5 meters of each other.

12. The system of claim 1, wherein the deployment times include at least two consecutive deployment times within 5 minutes.

13. The system of claim 1, wherein the OTV is configured to generate and transfer to each SV a data packet with one or both of (i) a time stamp and (ii) a location stamp indicative of a respective deployment time and/or a deployment location.

14. The system of claim 1, wherein the control unit is a distributed control unit located at (i) at least one terrestrial location and (ii) at least one space-based location.

15. The system of claim 1, wherein at least one of the signals received by the control unit is generated by one of the plurality of SVs.

16. The system of claim 1, further comprising:
one or more gate devices associated with at least one of the one or more waypoints and disposed at an altitude between 100 and 500 km,
wherein at least one of the signals received by the control unit is generated by one of the one or more gate devices.

17. The system of claim 1, further comprising a visualization system configured to display information about at least one of the plurality of SVs.

18. The system of claim 17, wherein the information includes at least one of i) an indication of time, ii) an indication of position, and/or iii) an indication of a metric of performance of at least one of the plurality of SVs.

19. The system of claim 17, wherein the information includes simultaneously displayed at least one of i) a respective indication of time, ii) a respective indication of position, and/or iii) a respective indication of a metric of performance of at least two of the plurality of SVs.

20. The system of claim 17, wherein:
the control unit is configured to compute for at least one of the at least two of the plurality of SVs an estimated indication of position at a given time; and
the information includes simultaneously displayed, for the at least two of the plurality of SVs the respective indication of position at the given time including the estimated indication of position.

21. The system of claim 17, wherein the visualization system is further configured to display an image indicative of a view from a perspective of at least one of the plurality of SVs.

22. The system of claim 21, wherein:
the image is based at least in part on an image captured by an onboard camera of the at least one of the plurality of SVs.

23. The system of claim 21, wherein:
the image is based at least in part on a computed star field from the perspective of the at least one of the plurality of SVs.

24. The system of claim 21, wherein:
the image includes an image of a second one of the plurality of SVs.

25. The system of claim 17, wherein:
the information about at least one of the plurality of SVs includes a graphical representation of the at least one of the plurality of SVs.

26. The system of claim 25, wherein:
the graphical representation is based at least in part on one or more computer-aided design (CAD) files representing the at least one of the plurality of SVs.

27. A method of managing a space vehicle competition, the method comprising:
simultaneously retaining a plurality of space vehicles (SVs) on an orbital transfer vehicle (OTV) while the OTV transfers the plurality of SVs from an initial altitude of a launch vehicle to a desired altitude;
deploying, by the OTV, the plurality of SVs at a series of offset deployment locations and respective offset deployment times representing starting points of the competition;
receiving, by a control unit, signals indicative of arrival times representing times at which one or more of the plurality of SVs are proximate to one or more waypoints along a course of the competition, and
computing, by a control unit, based at least in part on the arrival times, one or more metrics indicative of relative performance of the plurality of SVs in the competition.

28. The method of claim 27, further comprising:
receiving, by a control unit, signals indicative of the offset deployment locations and the respective offset deployment times of the plurality of SVs,
wherein computing the one or more metrics is further based on the offset deployment locations and the respective offset deployment times.
